(19) United States
(12) Patent Application Publication
(10) Pub. No.: US 2024/0417017 A1
(43) Pub. Date: Dec. 19, 2024

(54) PROTECTIVE EQUIPMENT DETECTION AND ACCIDENT SEVERITY DETECTION

(71) Applicant: LiveWire EV, LLC, Milwaukee, WI (US)

(72) Inventors: Stefan Gudmundsson, Morrisville, NC (US); Shahriar Ravari, San Diego, CA (US); Alekh Vaidya, San Diego, CA (US)

(21) Appl. No.: 18/747,817

(22) Filed: Jun. 19, 2024

Related U.S. Application Data
(60) Provisional application No. 63/509,012, filed on Jun. 19, 2023.

(51) Int. Cl. B62J 27/00; B62J 3/10; B62J 6/26

(52) U.S. Cl. CPC B62J 27/00; B62J 3/10; B62J 6/26

(57) ABSTRACT

Systems and methods for responding to a vehicular accident. One system includes a wireless communication interface of a vehicle and a controller including an electronic processor. The wireless communication interface is configured to wirelessly communicate with a remote device associated with a rider of the vehicle. In response to detection of an accident involving the vehicle, the electronic processor is configured to wirelessly transmit a signal from the wireless communication interface to the remote device, determine a distance between the wireless communication interface and the remote device based on the signal, determine an accident severity based on the determined distance between the wireless communication interface and the remote device, and, in response to determining the accident severity, initiate one or more actions to respond to the accident.

### RELATED APPLICATIONS

This application claims the benefit of U.S. Provisional Patent Application No. 63/509,012, filed on Jun. 19, 2023, the entirety of which is hereby incorporated by reference.

### TECHNICAL FIELD

Embodiments described herein generally relate to accident detection systems and methods for vehicles, such as, for example, motorcycles. Embodiments described herein also generally relate to detecting whether a rider of a vehicle is wearing a helmet (or other protective equipment) and controlling the vehicle accordingly.

### SUMMARY

When a cageless vehicle, such as, for example, a motorcycle, is involved in an accident, a rider may get separated from the vehicle and, in some embodiments, may not be able to contact an accident assistance service. However, as the severity of an accident may vary, triggering the same accident response actions anytime an accident is detected may waste resources (e.g., vehicle batteries, communication bandwidth, etc.).

Accordingly, embodiments described herein determine the severity of an accident based on data from one or more sensors or signals (e.g., a Bluetooth™ and/or ultra-wideband (UWB) signal, an accelerometer, etc.), vehicle information, or a combination thereof. For example, in response to detection of a potential accident (e.g., based on accelerometer data), a wireless signal (e.g., a Bluetooth™ and/or an ultra-wideband (UWB) signal) may be used to determine a distance between the vehicle and the rider (i.e., a wireless communication device associated with (e.g., carried by) the rider). This distance may be used to determine the severity of the accident, which may be used to trigger various responses, such as, for example, sending an alert to the rider's wireless communication device (e.g., to prompt the rider about whether an accident assistance service should be contacted), communicating accident information to an accident assistance service, turning on or activating (powering) one or more lights of the vehicle (e.g., a headlight or hazards), turning on a horn or other audible device (e.g., a sound-generating mechanism, such as a horn, a speaker, a siren, or the like) to attract attention to the vehicle, or a combination thereof. Factors taken into account when estimating the severity of an accident (and consequently determining what responses to initiate) may include a distance between a rider and the vehicle, changes in such distance over a predetermined period of time (e.g., indicating whether the rider is mobile), a number of riders (e.g., including any passengers) detected, whether a rider was wearing a helmet, or a combination thereof. One or more of these factors may also be communicated to an accident assistance service to aid such a service in responding to the accident. Location information may also be communicated, which may include a location of a detected rider relative to the vehicle in addition to a geographical location of the vehicle.

For example, in some embodiments, UWB and/or Bluetooth™ technology installed on the vehicle may be used with similar technology on a rider's personal wireless communication device (e.g., smart phone, headset, smart watch or other wearable, or the like) to measure the distance between the vehicle and the rider. In response to a controller on the vehicle detecting an accident (e.g., including, for example, a collision, a tip over situation, or other abnormal condition), the controller (or a separate controller installed in the vehicle) initiates a distance measurement using radio frequency (RF) measurements, such, as for example, using UWB and/or Bluetooth™ signals. In response to the measured distance between the rider and the vehicle being over a configurable value (and in response to such a measured distance remaining over the configurable value or at a steady distance for a configurable predetermined period of time), the controller on board the vehicle may initiate one or more response actions, such as, for example, contacting an accident assistance service (e.g., a call center or an emergency service) through a communication interface on the vehicle and/or the rider's personal wireless communication device. In some embodiments, before communicating with an accident assistance service, the controller may be configured to communicate a notification to the rider's personal wireless communication device prompting the user to confirm whether they need assistance (e.g., confirm their medical state and/or confirm whether an accident assistance service should be contacted). A predetermined response period may be associated with the notification, wherein, in response to not receiving a response to the notification within the predetermined response period, the controller may initiate communication with an accident assistance service and/or take other actions assuming that assistance is needed. Similarly, in response to the controller not being able to communicate with the rider's personal communication device after a predetermined number of attempts or time period, the controller may be configured to initiate communication or other actions assuming that assistance is needed (e.g., assuming that communication device was damaged during the accident).

Accordingly, by determining the relative position between the vehicle and a rider after an accident is detected, the extent and nature of the accident may be determined, which allows an appropriate response to be initiated. This determined position may also be communicated to an accident assistance service to help the accident assistance service quickly and accurately locate the rider at the scene, which may otherwise be difficult in certain terrains or circumstances (e.g., canyons, mountains, cliffs, swamps, during a storm or other weather event, etc.).

As noted above, in some embodiments, whether a rider is wearing a helmet (or other protective equipment) may be a factor used to determine a severity of an accident. A controller included in the vehicle may be configured to make such a determination using radio frequency signals, such as, for example, UWB signals that act as radar, wherein scanning around the head of a rider can provide information (e.g., based on reflections of such signals) used to detect whether the rider is wearing a helmet. For example, the differences in material, geometry, or both impact the reflection of the UWB signals, which can be used to determine whether the rider is wearing a helmet. The controller may be configured to make this determination in response to detection of an accident (by the controller or a separate controller or system). Alternatively or in addition, the controller may be configured to make the determination regarding the presence of protective equipment during operation of the vehicle (e.g., during start-up of the vehicle) and may store the information for subsequent use (e.g., referenced in response to detection of an accident). In addition, in some embodiments, the controller may control the vehicle based on whether the rider is wearing appropriate protective equipment, such as a helmet. For example, the controller may initiate one or more notifications (audible, visual, tactile, or a combination thereof) in response to detecting that the rider is not wearing a helmet. These notifications may be generated before the vehicle is started, during operation of the vehicle (e.g., when the vehicle is moving), or a combination thereof. Alternatively or in addition, the control unit may prevent the vehicle from being started or being operated in particular ways (e.g., exceed a predetermined speed, acceleration, or combination thereof) in response to detecting that the rider is not wearing a helmet. The controller may take into account other factors as part of this vehicle control, such as, for example, a time of day, a location of the vehicle, an age of the rider (e.g., determined based on a key associated with the rider or other identifier received by or read by the controller), insurance company incentives, active enablement by the rider, or a combination thereof. Using radio frequency waves to detect whether a rider is wearing a helmet or other protective equipment reduces complexity and processing requirements as compared to other techniques, such as, for example, computer vision techniques that rely on one or more rider-facing cameras, which may create privacy concerns and reduced adoption of safety features. As described herein, detecting the rider and/or characteristics of the rider may be used with accident detection and response and/or may be used separate from such detection as a way to encourage use of protective equipment and safe vehicle operation.

In some aspects, the techniques described herein relate to a system for responding to a vehicular accident. The system includes a wireless communication interface of a vehicle (e.g., installed on the vehicle) configured to wirelessly communicate with a remote device associated with a rider of the vehicle, and a controller (e.g., installed on the vehicle) including an electronic processor. In response to detection of an accident involving the vehicle, the electronic processor is configured to wirelessly transmit a signal from the wireless communication interface to the remote device, determine a distance between the wireless communication interface and the remote device based on the signal, determine an accident severity based on the determined distance between the wireless communication interface and the remote device, and, in response to determining the accident severity, initiate one or more actions to respond to the accident.

In some aspects, the electronic processor is further configured to determine a change in the distance between the wireless communication interface and the remote device (over a predetermined period of time or predetermined number of determinations) and is configured to determine the accident severity based on the determined distance, the change in the distance, or a combination thereof. In some aspects, the electronic processor is configured to determine the distance using at least one of a Time-of-Flight method and a Received Signal Strength method. In some aspects, the electronic processor is configured to initiate the one or more actions to respond to the accident by, in response to the distance exceeding a predetermined distance, transmitting a notification to the remote device prompting the rider to confirm a health state or confirm a need for assistance. In some aspects, the electronic processor is further configured to contact an accident assistance service in response to not receiving a response to the notification within a predetermined period of time (i.e., a predetermined response time). In some aspects, the electronic processor is configured to initiate the one or more actions to respond to the accident by contacting an accident assistance service and communicating, to the accident assistance service, a location of the rider with respect to the vehicle based on the determined distance.

In some aspects, the techniques described herein relate to a method for controlling vehicle operation. The method includes generating wireless signals by a transceiver of the vehicle, wherein the transceiver is positioned to direct the wireless signals toward a seat of the vehicle. The method also includes detecting reflections of the wireless signals by the transceiver, determining, with an electronic processor of the vehicle, whether a rider of the vehicle is wearing protective equipment based on the reflections, and, in response to determining that the rider is not wearing protective equipment, initiating a response via the vehicle. In some aspects, the response includes at least one selected from a group consisting of providing a notification on a user interface of the vehicle and playing or generating a sound (e.g., via a speaker or other sound-generating mechanism of the vehicle). In some aspects, the wireless signals includes ultra-wide band signals. In some aspects, the protective equipment includes a helmet. In some aspects, the response includes limiting operation of the vehicle. In some aspects, limiting operation of the vehicle includes at least one selected from a group consisting of preventing starting of the vehicle, limiting a speed of the vehicle, limiting an acceleration of the vehicle, and disabling one or more vehicle systems.

In some aspects, the techniques described herein relate to a system for responding to a vehicular accident. The system includes a sensor assembly of a vehicle, a wireless communication interface of the vehicle, and a controller including an electronic processor. The sensor assembly includes a transceiver configured to generate and transmit a first wireless signal toward a seat of the vehicle and detect a reflection of the first wireless signal. The wireless communication interface of the vehicle is configured to wirelessly communicate with a remote device associated with a rider of the vehicle. The electronic processor is configured to determine whether the rider of the vehicle is wearing protective equipment based on the detected reflections of the first wireless signal. In response to detection of an accident involving the vehicle, the electronic processor is further configured to transmit a second wireless signal from the wireless communication interface to the remote device, determine a distance between the wireless communication interface and the remote device based on the second wireless signal, determine an accident severity based on the determined distance between the wireless communication interface and the remote device and the determination of whether the rider of the vehicle is wearing protective equipment, and initiate one or more actions to respond to the accident based on the determined accident severity.

In some aspects, the first wireless signal includes an ultra-wideband signal. In some aspects, the second wireless signal includes a short-range wireless signal, such as, for example, a signal based on a Bluetooth™ standard. In some aspects, the electronic processor is configured to determine the distance using a Received Signal Strength method. In some aspects, the protective equipment includes a helmet. In some aspects, the one or more actions includes at least one selected from a group consisting of communicating a notification to the remote device, communicating with an accident assistance service, activating a light of the vehicle, and activating a sound-generating mechanism of the vehicle. In some aspects, the electronic processor is further configured to transmit at least one of the accident severity and information indicative of whether the rider is wearing protective equipment to an accident assistance service. In some aspects, the electronic processor is further configured to transmit, to an accident assistance service, location information of the rider relative to the vehicle based on the determined distance.

Other independent aspects will become apparent by consideration of the detailed description and accompanying drawings.

### BRIEF DESCRIPTION OF THE DRAWINGS

FIG. 1 is a side view of a vehicle according to some examples and aspects.

FIG. 2 schematically illustrates a control system included in the vehicle illustrated in FIG. 1 according to some examples and aspects.

FIG. 3 is a flowchart illustrating a process performed via the control system of FIG. 2 for detecting whether a rider is wearing protective gear, according to some aspects and examples.

FIG. 4 is a side view of the vehicle of FIG. 1 and an associated detection zone according to some examples and aspects.

FIG. 5 schematically illustrates a control system included in the vehicle illustrated in FIG. 1 according to some examples and aspects.

FIG. 6 is a flowchart illustrating a process performed via the control system of FIG. 5 for determining accident severity, according to some aspects and examples.

### DETAILED DESCRIPTION

Before any independent embodiments are explained in detail, it is to be understood that the methods and systems described herein are not limited in their application to the details of construction and the arrangement of components set forth in the following description or illustrated in the following drawings. The systems and methods described herein are capable of other independent embodiments and of being practiced or of being carried out in various ways. Some embodiments described herein may be integral to a vehicle while others may be peripheral to a vehicle controller or distributed between an integral component and a peripheral component.

Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof.

Relative terminology, such as, for example, “about”, “approximately”, “substantially”, etc., used in connection with a quantity or condition would be understood by those of ordinary skill to be inclusive of the stated value and has the meaning dictated by the context (for example, the term includes at least the degree of error associated with the measurement of, tolerances (e.g., manufacturing, assembly, use, etc.) associated with the particular value, etc.). Such terminology should also be considered as disclosing the range defined by the absolute values of the two endpoints. For example, the expression “from about 2 to about 4” also discloses the range “from 2 to 4”. In another example, the expression “approximately 0” may disclose the absence of a value to within at least a degree of reasonable tolerance. The relative terminology may refer to plus or minus a percentage (e.g., 1%, 5%, 10% or more) of an indicated value.

Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not listed.

Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

Many of the modules and logical structures described are capable of being implemented in software executed by a microprocessor or a similar device or of being implemented in hardware using a variety of components including, for example, application specific integrated circuits (“ASICs”). Terms like “controller” and “module” may include or refer to both hardware and/or software. Capitalized terms conform to common practices and help correlate the description with the coding examples, equations, and/or drawings. However, no specific meaning is implied or should be inferred simply due to the use of capitalization. Thus, the claims should not be limited to the specific examples or terminology or to any specific hardware or software implementation or combination of software or hardware. Also, if an apparatus, method, or system is claimed, for example, as including a controller, module, logic, electronic processor, or other element configured in a certain manner, for example, to perform multiple functions, the claim or claim element should be interpreted as meaning one or more controllers, modules, logic elements, electronic processors other elements where any one of the one or more elements is configured as claimed, for example, to perform any one or more of the recited multiple functions.

### Protective Gear Detection

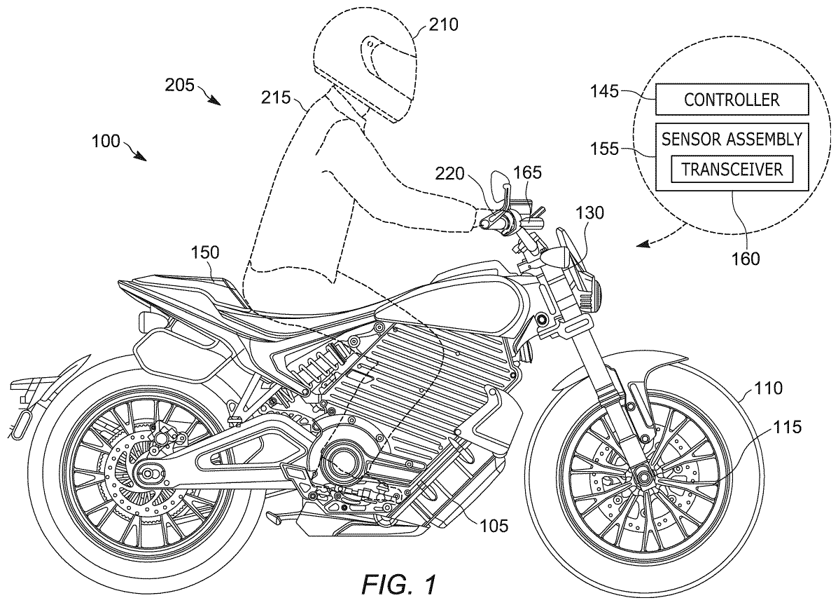

FIG. 1 is a side views of a vehicle according to some examples and aspects. The vehicle in FIG. 1 is illustrated as an electric motorcycle 100. However, it should be understood that the methods and systems described herein are not limited to use on electric motorcycles but may be used in other types of vehicles, including internal combustion engine vehicles and hybrid vehicles. For example, in some embodiments, the methods and systems described herein may be used on cageless vehicles, such as, for example, a motorized scooter, an all-terrain vehicle (ATV), a light utility vehicle, a moped, a go-kart, a bicycle, or any other type of vehicle that does not include an enclosed cabin.

As illustrated in FIG. 1, the motorcycle 100 includes an electric motor 105, tires 110 on wheels 115, and a rechargeable power source, such as a battery 125. The motorcycle 100 includes a frame 130, a controller 145 configured to control elements of the motorcycle 100, and a sensor assembly 155. The motorcycle 100 also includes a seat 150 configured to receive a rider 205. The controller 145 may be located at various locations on the motorcycle 100. For example, the controller 145 may be located near a user interface 165 that is configured to provide information related to the motorcycle 100 but could also be located at other locations on the motorcycle 100. In some examples, the sensor assembly 155 is also located in an instrument cluster near the user interface. Alternatively or in addition, the sensor assembly 155 (or one or more sensors included in the sensor assembly 155) may be located near the seat 150 or on the frame 130 of the motorcycle 100. In some embodiments, one or more sensors (e.g., transceivers) included in the sensor assembly 155 are positioned to direct signals toward the rider 205 (e.g., toward the seat 150) and detect signals reflected from the rider 205.

In some instances, the sensor assembly 155 includes one or more ultra-wideband (UWB) sensors, also referred to as herein as transceivers 160, configured to detect the rider 205 and/or characteristics of the rider 205. The transceiver 160 may detect the rider 205 by emitting short, high-frequency radio pulses and detecting reflections of such radio pulses (e.g., via the transceiver 160). The transceiver 160 transmits information regarding the transmitted pulses, detected reflected pulses, or both to the controller 145, and the controller 145 uses the information from the transceiver 160 to determine one or more characteristics of the rider 205, such as, for example, whether a rider 205 is present, a height or other measurement of the rider 205, a position of the rider 205 (e.g., distance from the sensor assembly 155, whether the rider is wearing protective equipment (e.g., a helmet 210, a jacket 215, gloves 220, or a combination thereof), a number of riders (e.g., by detecting a number of arms, heads, or the like), or a combination thereof. For example, the differences in material/geometry between a helmet and rider's head may be used to determine absence or presence of a helmet. As one non-limiting example, UWB technology uses pulse lengths generally in the same order of magnitude as potential targets. Accordingly, as compared to other radar technology with longer pulse widths, UWB pulses reflected from a target are changed by the characteristics (e.g., structure and material) of the target. Accordingly, changes in pulse waveform of the reflected signals can provide information regarding the target in addition to mere location or presence, such as, for example, shape and material properties of the target.

In embodiments wherein UWB technology is used, the transceiver 160 is configured to operate in the ultra-wideband frequency band of 3.1 GHz to 10.6 GHZ, and the transceiver 160 may transmit and detect a wide assortment of frequencies within the operating frequency range, allowing the transceiver 160 to achieve high accuracy and precision when detecting the rider 205 or characteristics of the rider 205. In some examples, as an alternative to ultra-wide band, the transceiver 160 may be configured as a LIDAR transceiver, an X-band radar transceiver operating in an 8 GHz to 12 GHz range, a Ku-band radar transceiver operating in a 12 GHz to 18 GHz range, W-band radar transceiver operating in a 75 GHz to 110 GHz range, or an L-band radar transceiver operating in a 1 GHz to 2 GHz range. In other embodiments, the transceiver 160 may operate in other frequency ranges or use other types of radar-based technologies. By using UWB pulses or other radar-based technologies, the sensor assembly 155 is configured to detect the rider 205 and/or characteristics of the rider 205 without the need for a camera, which may avoid data privacy issues, may be more acceptable to and therefore used by riders 205 (e.g., riders may turn off cameras due to privacy concerns), reduce costs and complexity, or a combination thereof. It should be understood that, in some embodiments, the transceiver 160 may be configured to process detected signals and, for example, detect the rider 205 and/or one or more characteristics of the rider 205 in place of or in addition to the controller 145. In other words, functionality described herein as being performed via the controller 145 may be distributed between the controller 145 and the sensor assembly 155 (e.g., transceiver 160 and/or other components) in various configurations. Also, in some embodiments, multiple controllers included in the motorcycle 100 may be configured to process data collected via the sensor assembly 155. Furthermore, in some examples, the transceiver 160 may be configured as separate elements of a transmitter component and a receiver component. For instance, in some examples, the sensor assembly 155 includes a transmitter configured to transmit UWB pulses and a separate receiver configured to receive or detect reflected UWB pulses.

In some instances, the user interface 165 includes one or more indicators, such as, for example, a speedometer, odometer, tachometer, fuel gauge or remaining battery life gauge, and may include various alert lights configured to alert the rider 205 to conditions impacting the motorcycle 100. The indicators may be provided via one or more light-emitting diodes (LEDs), lights or telltales, speakers, tactile outputs, mechanical gauges, or other physical mechanisms, virtually as part of a graphical user interface provided on one or more screens (e.g., touchscreens), or a combination thereof. The controller 145 may be configured to provide information via the user interface 165 based on the detected rider 205 or characteristics thereof. For instance, as described in more detail below, in response to the controller 145 detecting that the rider 205 is operating the motorcycle 100 without wearing a helmet 210 (based on data detected via the sensor assembly 155), the controller 145 provides a notification via the user interface 165 to notify the rider 205 no helmet was detected. The notification may include illuminating an alert light or providing the notification in the user interface 165, playing or outputting a sound, such as a chime or beep, or a combination thereof.

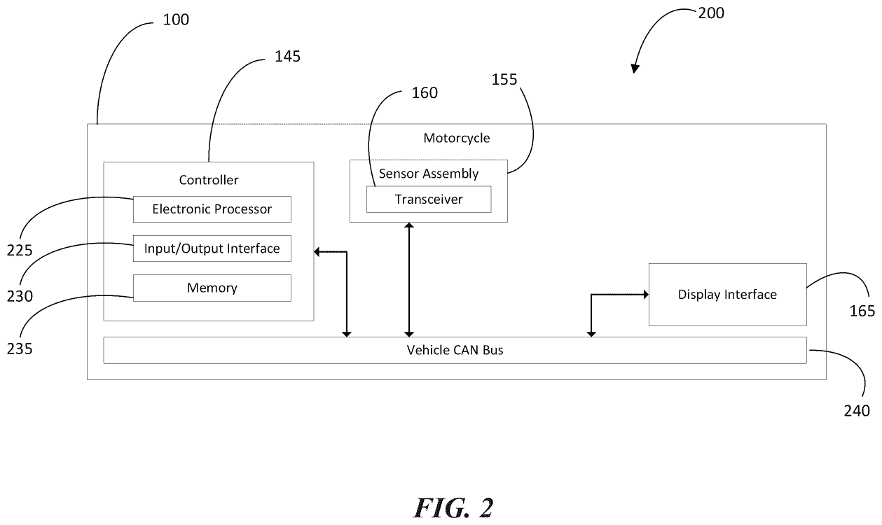

FIG. 2 schematically illustrates a control system 200 of the motorcycle 100. The control system 200 includes the sensor assembly 155 and the controller 145, which may include an electronic processor 225, an input/output interface 230, and a memory 235. In some examples, the controller 145 is integrated with the sensor assembly 155. However, in the example shown in FIG. 2, the controller 145 and the sensor assembly 155 are separate and communicate with each other via a controller area network bus interface, also referred to as CAN bus 240, or similar wired or wireless connection. When the controller 145 and the sensor assembly 155 are separate, the sensor assembly 155 may also include an electronic processor, an input/output interface, and a memory separate from those of the controller 145. Again, it should be understood that functionality described herein as being performed by the controller 145 may be distributed among multiple controllers of the vehicle and/or among components of the sensor assembly 155. Accordingly, functionality described herein as being performed by the sensor assembly 155 (or a particular sensor or transceiver included in such an assembly) may be performed via the controller 145.

In some examples, the electronic processor 225 is implemented as a microprocessor with separate memory, for example the memory 235. In other examples, the electronic processor 225 may be implemented as a microcontroller (with memory 235 on the same chip). In other examples, the electronic processor 225 may be implemented using multiple processors. In addition, the electronic processor 225 may be implemented partially or entirely as, for example, a field-programmable gate array (FPGA), an applications specific integrated circuit (ASIC), and the like and the memory 235 may not be needed or be modified accordingly. In some examples, the memory 235 includes non-transitory, computer-readable memory that stores instructions that are received and executed by the electronic processor 225 to carry out methods described herein. The memory 235 may include, for example, a program storage area and a data storage area. The program storage area and the data storage area may include combinations of different types of memory, for example read-only memory and random-access memory. The input/output interface 230 may include one or more input mechanisms and one or more output mechanisms (for example, general-purpose input/outputs (GPIOs), analog inputs, digital inputs, and others). As illustrated in FIG. 2, the wireless communication device 170 and the user interface 165 also communicate with the controller 145 via the CAN bus 240.

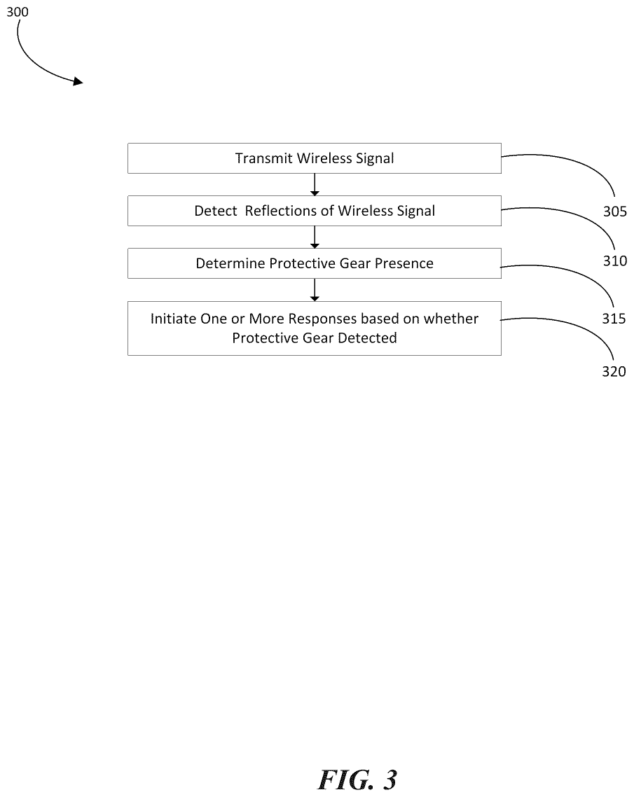

FIG. 3 is a flowchart illustrating a process 300 for detecting the rider 205 and/or characteristics of the rider using the control system 200 (e.g., the sensor assembly 155 and the controller 145), according to some aspects and examples. The process 300 is described herein as being used to detect whether the rider 205 is wearing a helmet 210. However, the process 300 may similarly be used to detect other characteristics of the rider 205 as noted above (e.g., whether the rider 205 is present, a dimension or location of the rider 205, whether the rider 205 is wearing other protection equipment, a number of riders, or the like). As illustrated in FIG. 3, the process 300 includes generating and transmitting a wireless signal via the transceiver 160 (at 305). As noted above, in some examples, the wireless signal is an ultra-wideband signal. As also described above, the transmitted wireless signal is directed toward the seat 150 of the motorcycle 100. The process 300 also includes detecting reflections of the transmitted wireless signal (via the transceiver 160) (at 310) and using the detected reflections to determine (at 315) whether the rider 205 of the motorcycle 100 is wearing protective gear, such as the helmet 210.

As illustrated in FIG. 3, the process 300 also includes automatically (without interaction from the rider 205 or another user) initiating a response via the motorcycle 100 (at 320) in response to determining that the rider 205 is not wearing protective gear, such as, for example, a helmet 210. The response may include providing a notification. For example, controller 145 may control the user interface to illuminate (and optionally flash) a light or LED, play a sound (a beep or chimp), or a combination thereof to notify the rider 205 that the helmet 210 has not been detected. Additionally or alternatively, the controller 145 may control aspects of the motorcycle 100 in response to determining that the rider 205 is not wearing protective gear. For example, the controller 145 may prevent the motorcycle 100 from starting or may limit certain operations of the motorcycle, such as maximum operating speed. Other limits or restrictions may exist in other examples (e.g., disabling operation of cruise control, infotainment systems, or other likely distractions for the rider, establishing a maximum acceleration, establishing a maximum travel distance, or the like).

In some instances, the controller 145 may be programmed with (or may access a remote source of) information regarding traffic laws, such as if wearing a helmet is legally required. The controller 145 may use this information along with a current location of the motorcycle 100 (which may be obtained from a navigation system of motorcycle 100) to determine if protective gear, such as helmet 210, is required. In such situations, the controller 145 may be configured to prevent or limit operation of the motorcycle 100 in response to determining that the rider 205 is not wearing protective gear and/or may be configured to generate a notification as described above. In other words, the controller 145 may use the traffic law information to restrict notifications and/or other control aspects to geographical locations that require particular protective gear. In some instances, the controller 145 uses additional identifiers about the rider 205 in conjunction with the determination that the rider 205 is or is not wearing protective gear. For example, in some geographic areas, helmets may be required for children but not required for adults. The controller 145 may obtain an age of the rider 205, for example, from a remote device, from a key used by the rider 205 to operate the motorcycle 100, another identifier provided via the rider 205, or a combination thereof.

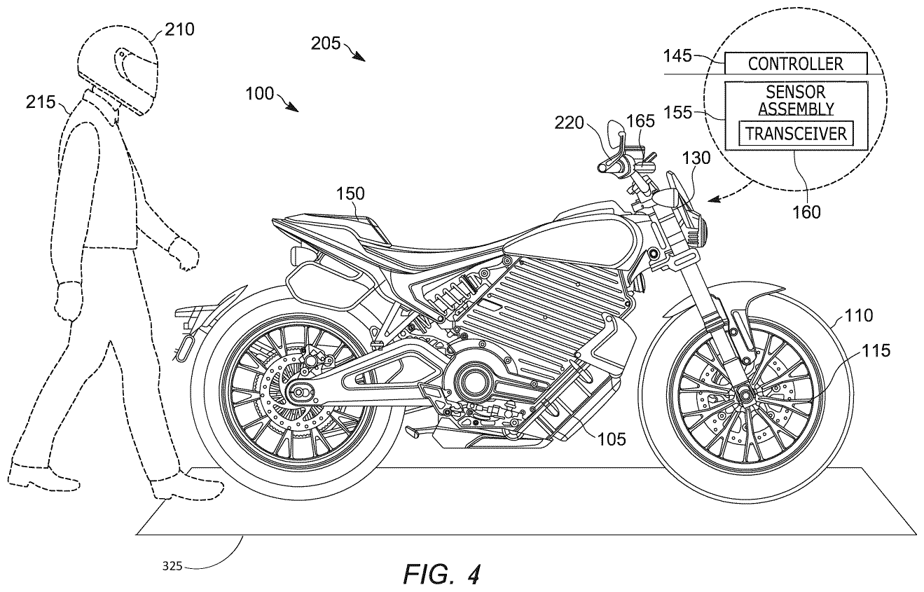

In some embodiments, the sensor assembly 155 may be used for multiple purposes. For example, in addition to or separate from detecting protective equipment, the sensor assembly 155 may be used to detect unauthorized access or movement of the motorcycle 100 (e.g., detect tampering and issue an associated alert). For example, FIG. 4 illustrates the motorcycle 100 and an associated detection zone 325. Using such a zone and a similar process as process 300, unauthorized access to the motorcycle 100 can be detected. Unauthorized access to the motorcycle 100 can include moving or touching the motorcycle 100 or components of the motorcycle (i.e., the handlebars, seats, lights, compartments, license plate, etc.). In some examples, unauthorized access may include sitting on the motorcycle 100 or touching or movement of the handlebars. The controller 145 may be configured to use information received from the sensor assembly 155 to detect unauthorized access (i.e., presence or movement within the zone 325) and trigger a tamper alert.

The zone 325 may include an area on the ground surrounding at least a portion of the motorcycle 100, a multi-dimensional area around at least a portion of the motorcycle 100, or a distance from or an area around a part of the motorcycle 100. For example, the zone 325 may define an area around the seat or the handlebars and may have a range of a few centimeters or meters (e.g., 1 centimeter to 30 centimeters, 1 meter, or the like). As noted above, in response to detecting an object or movement within the zone 325 based on information from the sensor assembly 155, the controller 145 may generate an alert. The alert may include a message (e.g., an email message or text message) transmitted to an external device, such as the rider's wireless communication device, or a notification provided within an application executed on the rider's wireless communication device. Alternatively or in addition, the alert may include blinking (turning on and off) one or more lights of the motorcycle 100, honking the horn, activating similar alarms, or a combination thereof. In some aspects, the size, shape, position, or combination thereof of the zone 325 may be configurable by the rider 205 or may be predetermined. Also, in some embodiments, the size, shape, position, or combination thereof of the zone may vary based on a state of the motorcycle 100, one or more environmental parameters, or a combination thereof. Also, in some aspects, the controller 145 may receive information regarding the zone 325 via sensors that are not a part of the sensor assembly 155, such as a camera. Although the zone 325 is illustrated in FIG. 4 as a zone located underneath the motorcycle 100, it should be understood that the zone 325 may comprise any space around the motorcycle 100 and is not limited to a space on the road or surface occupied by the motorcycle 100.

### Accident Severity Detection

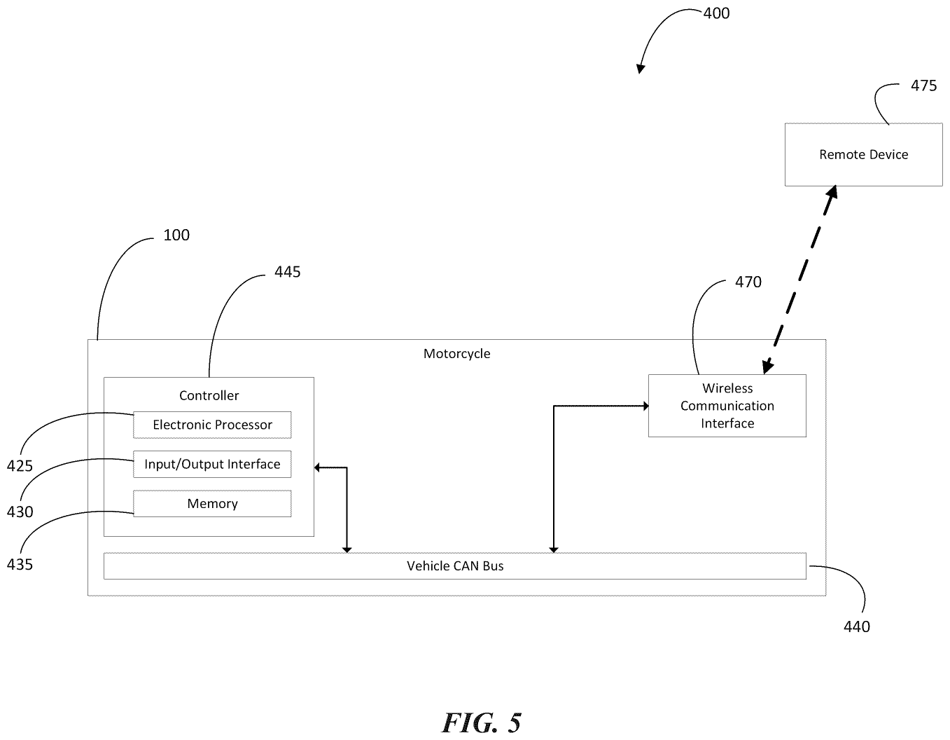

As illustrated in FIG. 5, in some embodiments, in addition to the sensor assembly 155 described above for detecting the rider 205 and/or characteristics of the rider 205 or separate and independent from the sensor assembly 155 and associated functionality, the motorcycle 100 include a wireless communication device 470 configured to receive and transmit wireless communications with a remote device 475. The wireless communication device 470 may also be configured to wirelessly communicate with remote networks, such as cellular networks, global positioning satellite (GPS) networks, or one or more accident assistance services.

The wireless communication device 470 may communicate with the remote device 475 in one or more ways (e.g., using one or more communication networks, channels, protocols, standards, etc.). For instance, the wireless communication device 470 may communicate with the remote device 475 using a Wi-Fi communication, such as the IEEE 802.11 standard operating in the 2.4 GHz or 5 GHz frequency bands. Alternative communications may include short-range wireless signals based on a Bluetooth™ standard (e.g., operating in a 2.4 GHz frequency band and using a Bluetooth™ protocol), Near Field Communication (NFC) technologies, Infrared (IR) communication technologies, UWB communication technologies, or the like. In some instances, the remote device 475 is a mobile phone that may be paired with the motorcycle 100 (e.g., for infotainment purposes, hands-free operation of the remote device 475, or a combination thereof). The remote device 475 may similarly be a wearable device (e.g., a smart watch, smart glasses, smart helmet, or the like), a tablet computer, or the like. As described in more detail below, the wireless communication device 470 may also be used to determine a distance between the rider 205 and the motorcycle 100, such as, for example, when an accident is detected. As used herein, an “accident” or “vehicular accident” may include an accident involving a vehicle, such as, for example, the motorcycle 100, and may include one vehicle impacting or colliding with another object (e.g., another vehicle or a non-vehicle object), a loss of control situation of a vehicle (e.g., the motorcycle 100 rolling over, sliding, skidding, tipping-over, or the like), or a combination thereof.

As illustrated in FIG. 5, the wireless communication device 470 may be included as part of a control system 400 of the motorcycle 100. The control system 400 includes the wireless communication device 470, and a controller 445, which may include an electronic processor 425, an input/output interface 430, and a memory 435. In some examples, the controller 445 is integrated with the wireless communication device 470. However, in the example shown in FIG. 5, the wireless communication device 470 and the controller 445 are separate and communicate with each other via a controller area network bus interface, also referred to as CAN bus 440, or similar wired or wireless connection. When the controller 445 and the wireless communication device 470 are separate, the wireless communication device 470 may also include an electronic processor, an input/output interface (e.g., a wireless transceiver), and a memory separate from those of the controller 445. The motorcycle 100 may include additional sensors and/or transceivers (not shown) configured to detect motorcycle speed, acceleration, location, and the like, which may be used to detect an accident. These sensors and transceivers are similarly configured to transmit data to the controller 445, such as, for example, over the CAN bus 440. For instance, an accelerometer may detect acceleration values. By monitoring acceleration values and/or changes in acceleration, the controller 445 may use data detected via the accelerometer (alone or in combination with data from other sensors and systems) to identify accidents. In response to identifying an accident, the controller 445 may output an accident detection signal, which may be used by other controllers or devices included in the motorcycle 100 (e.g., to initiate various response actions).

The controller 445 may be configured to initiate one or more response actions to respond to a detected accident as described in further detail below. Again, it should be understood that functionality described herein as being performed by the controller 445 may be distributed among multiple controllers of the vehicle and/or among components of the wireless communication device 470. Accordingly, functionality described herein as being performed by the wireless communication device 470 (or a particular sensor or transceiver included in such an assembly) may be performed the controller 445.

In some examples, the electronic processor 425, memory 435, and input/output interface 430 are similar to the electronic processor 225, memory 235, and input/output interface 230 described above with respect to the control system 200 and, thus, are not described herein for sake of brevity.

As previously described, the wireless communication device 470 communicates with the remote device 475, and the controller 445 may use this communication to determine the distance between the wireless communication device 470 and the remote device 475, such as, for example, by using Time-of-Flight (ToF) methods. For instance, the controller 445 may determine the distance between wireless communication device 470 and a similar communication device in the remote device 475 based on the time it takes for a signal to travel between the wireless communication device 470 and the remote device 475. The controller 445 may use other techniques to determine the distance, such as, for example, a Received Signal Strength Indicator (RSSI), where the measurement of the power present in a received radio signal may indicate a proximity between the devices 470 and 475. RSSI is measured in decibels (dBm), and a higher RSSI value indicates a stronger signal, while a lower RSSI value indicates a weaker signal. Additionally or alternatively, the controller 445 may use channel sounding to determine the distance. Channel sounding measures the characteristics of a wireless channel, or the path, that a signal takes between the wireless communication device 470 and the remote device 475. The characteristics of a wireless channel can vary depending on the environment, such as the presence of obstacles, buildings, and other objects, and may indicate a distance between the devices 470 and 475. Additionally or alternatively, the controller 445 may use a reported location of the remote device 475 (e.g., as determined by the remote device 475 using GPS or other navigation signals, or similar location determination methodologies) to determine a distance, such as, for example, by comparing a known location of the motorcycle 100 to the reported location of the remote device 475.

The controller 445 uses the distance between the wireless communication device 470 and the remote device 475 is used to determine the severity of an accident. For example, a small distance (e.g., 1-5 meters) between the wireless communication device 470 and the remote device 475 may indicate a minor accident because the rider 205 stayed with the motorcycle 100. On the other hand, a large distance (e.g., 5-10 meters or greater than 10 meters) may indicate that the accident was severe and that the rider 205 may need assistance. In some instances, the controller 445 is configured to collect metadata from the remote device 475, such as location, connection status, rider information, or information gathered from sensors on the remote device 475, such as accelerometer data. This metadata can then be used by the controller 445 in conjunction with the distance from the remote device 475 to determine accident severity. This metadata may also be communicated with an accident assistance service as part of reporting an accident and/or requesting assistance.

In some instances, the controller 445 may be programmed with multiple severity thresholds and be configured to perform different tasks based upon the thresholds. For instance, if the controller 445 determines that the accident is “minor” (based on the determined distance and/or a severity value or score calculated based on the distance as well as one or more other factors, exceeding a “minor” threshold), the controller 445 may prompt the rider 205 with an alert or notification offering assistance or a connection to one or more accident assistance services. In response to the controller 445 determining that the accident is “severe” (e.g., the severity satisfies a “severe” threshold), the controller 445 may automatically transmit data to one or more accident services (e.g., a call center, an emergency or first responder service, or the like). The transmitted data may include metadata collected from the remote device 475, the accident severity determination, information regarding the motorcycle 100, the rider 205, or both (including whether the rider 205 was wearing a helmet as determined as described above). In some instances, an accident assistance service may include a local emergency telephone number (e.g., a 9-1-1 call center). In other instances, an accident assistance service may include a third-party roadside assistance service.

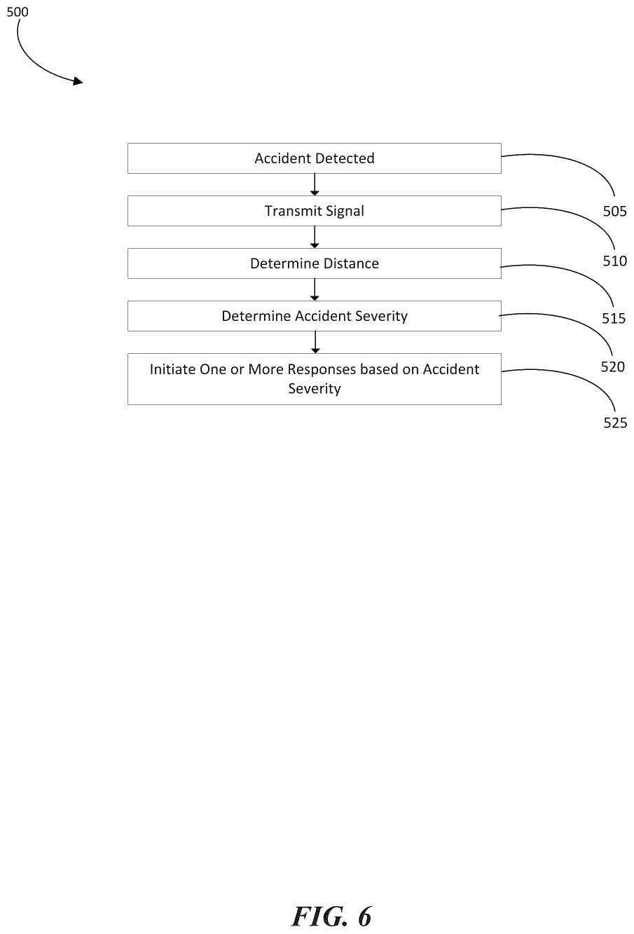

For example, FIG. 6 is a flowchart illustrating a process 500 for determining accident severity performed by the control system 400 (e.g., the controller 445 and the wireless communication device 470), according to some aspects and examples. As previously described, the motorcycle 100 may include sensors, wherein data detected by these sensors (e.g., accelerometers, force sensors, speed sensors, or a combination thereof) may be processed by the controller 445 to detect whether an accident has occurred (at 505). In response to detection of an accident (which may be detected by the controller 445 or a separate controller or system), the controller 445 controls the wireless communication device 470 to transmit a signal to the remote device 475 (at 510). The controller 445 uses the transmitted signal to determine a distance (at 515) between the wireless communication device 470 and the remote device 475. In some instances, the wireless communication device 470 may transmit a number of signals to measure the distance between the devices 470 and 475, and, as also described above, may use ToF, RSSI, or similar wireless signal-based technologies to determine the distance. The controller 145 may use the determined distance to determine a severity of the accident (at 520).

The controller 445 may determine accident severity in a number of ways. In some instances, the controller 445 determines accident severity by using the determined determination (at 515) alone, wherein different distance ranges are associated with different severity levels. Alternatively, the controller 445 may determine accident severity (e.g., represented as a score or level) based on the determined distance in conjunction with other vehicle data detected by one or more sensors of the motorcycle 100, metadata received from the remote device 475, or a combination thereof. For example, the controller 145 may use vehicle speed, changes in vehicle speed, or acceleration values to determine accident severity. The controller 145 may use the accident severity determination to automatically (e.g., without rider interaction) initiate one or more responses or courses of action.

In response to determining the accident severity (at 520), the controller 445 initiates one or more responses or courses of actions based on the severity (at 525). As noted above, mapping the response to the severity level (e.g., through the use of various thresholds) avoids wasting resources taking actions that may not be needed for minor accidents or may not be helpful for more severe accidents. One response may include transmitting (e.g., via the wireless communication device 470) a notification to the remote device 475. The notification may be a text message, an email message, a push notification, a Bluetooth™ communication or signal, or the like, that informs the rider 205 that an accident was detected. The notification may prompt the rider 205 to confirm (e.g., positively or negatively) whether an accident did occur, whether the rider 205 is okay or needs assistance, or a combination thereof. Based on user input received in response to the notification, the controller 445 may take additional actions. For example, in response to the rider 205 indicating that they are not okay or that they need assistance, the controller 445 may be configured to automatically (without further instruction or command from the rider 205) contact one or more accident assistance services. The controller 445 may provide an accident assistance service with information regarding the detected accident (e.g., the determined accident severity, the determined distance, acceleration, speed, location, metadata received from the remote device, rider information, vehicle information, etc.). The controller 445 may similarly transmit information in response to not receiving a response to the notification within a predetermined time period (i.e., a predetermined response time), which may indicate that the rider 205 is unable to respond.

In some embodiments, the controller 445 may repeatedly determine a distance between the wireless communication device 470 and the remote device 475 after detection of an accident and may determine changes in the distance over a predetermined period of time (or between a predetermined number of distance determinations), which may indicate whether the rider 205 is moving. The controller 445 may use this information to set the accident severity, determine when to initiate a response (e.g., only after the determined distance exceeds a threshold and does not change by more than a predetermined amount within a predetermined amount of time), what response to initiate (e.g., whether to prompt a user or immediately contact an accident assistance service), what data to transmit to one or more accident assistance services, or a combination thereof. For example, in response to determining that the rider is not moving after detection of an accident, the controller 445 may prioritize contacting an accident assistance service, such as, for example, an emergency call center.

### Combined Approach

In some embodiments, the rider detection process and the accident severity process may be combined. For example, the motorcycle 100 may include both the control system 200 and the control system 400 (or a combination thereof, which may combine and distribute functionality across one or more controllers or other devices) and the determination of whether the rider 205 is wearing protection equipment, such as, for example, a helmet 210, may be used by the controller 445 to determine accident severity (e.g., as part of block 520 in the process 500) and/or determine what (if any) responses to generate (e.g., as part of block 525 in the process 500). For example, given similarities in a detected accident in terms of acceleration and force, a detected accident may be classified as more severe when the rider 205 was not wearing a helmet as compared to when the rider 205 was wearing a helmet. Accordingly, in some situations, if the transceiver 160 previously did not detect the presence of the helmet 210 on the rider 205, the controller 445 may classify a detected accident as severe even in cases where the accident may otherwise be classified as minor. The controller 445 may also transmit information regarding the detected presence of protected gear as part of contacting an accident assistance service. For example, if no helmet 210 was detected, the controller 445 may notify an accident assistance service that the rider 205 was not be wearing particular protective equipment and/or that the rider 205 may have specific types of injuries such as head, neck, or upper torso trauma.

The controller 445 may use stored information regarding whether protection equipment was detected (prior to an accident) and/or may attempt to make this determination when an accident is detected. To detect the presence of protective gear after an accident is detected, the motorcycle 100 may include additional UWB or other radar-based transceivers on the motorcycle 100 directed in various directions as the rider 205 may not be positioned on the seat 150 during or after a detected accident. When such a configuration, the UWB or other radar-based transceivers may also be used to determine a distance between the motorcycle 100 and the rider 205, which may be used in addition to separately from determining a distance using communication with the remote device 475. For example, if the remote device 475 is damaged during the accident or separated from the motorcycle 100 out of range of the wireless communication device, a distance may not be able to be determined using the process described above. However, in this situation, UWB or other radar-based technologies may be used to detect the rider 205 around the motorcycle 100 and, optionally, detect whether the rider 205 is wearing a helmet or other protection gear. In some embodiments, the UWB or other radar-based technologies may be used to detect a health status of the rider 205, such as, for example, by detecting breathing, movement, or other health-related characteristics.

Thus, embodiments described herein provide systems and methods for protective gear detection and accident severity determination for a motorcycle. It should be understood that the processes described herein may be used independently or in combination. Also, although the system and associated methods have been described in detail with reference to certain preferred embodiments, variations and modifications exist within the scope and spirit of one or more independent aspects of the described processes and associated systems and devices as described. One or more independent features and/or independent advantages of the protective gear detection and accident severity determination methods may be set forth in the claims.

What is claimed is:

1. A system for responding to a vehicular accident, the system comprising:
a wireless communication interface of a vehicle, the wireless communication interface configured to wirelessly communicate with a remote device associated with a rider of the vehicle; and
a controller including an electronic processor, in response to detection of an accident involving the vehicle, the electronic processor is configured to:
wirelessly transmit a signal from the wireless communication interface to the remote device,
determine a distance between the wireless communication interface and the remote device based on the signal,
determine an accident severity based on the determined distance between the wireless communication interface and the remote device, and
in response to determining the accident severity, initiate one or more actions to respond to the accident.

2. The system of claim 1, wherein the electronic processor is further configured to determine a change in the distance between the wireless communication interface and the remote device and determine the accident severity based on the change in the distance.

3. The system of claim 1, wherein the electronic processor is configured to determine the distance using at least one selected from a group consisting of a Time-of-Flight method and a Received Signal Strength method.

4. The system of claim 1, wherein the electronic processor is configured to initiate the one or more actions to respond to the accident by, in response to the determined distance exceeding a predetermined distance, transmitting a notification to the remote device prompting the rider to confirm a health state or confirm a need for assistance.

5. The system of claim 4, wherein the electronic processor is further configured to, in response to not receiving a response to the notification within a predetermined period of time, contact an accident assistance service.

6. The system of claim 1, wherein the electronic processor is configured to initiate the one or more actions to respond to the accident by contacting an accident assistance service and communicating, to the accident assistance service, a location of the rider with respect to the vehicle based on the determined distance.

7. A method for controlling vehicle operation, the method comprising:
generating wireless signals by a transceiver of the vehicle, the transceiver positioned to direct the wireless signals toward a seat of the vehicle;
detecting reflections of the wireless signals by the transceiver;
determining, with an electronic processor, whether a rider of the vehicle is wearing protective equipment based on the reflections; and
in response to determining that the rider is not wearing protective equipment, initiating a response via the vehicle.

8. The method of claim 7, wherein the response includes at least one of providing a notification on a user interface of the vehicle and a playing a sound via a sound-generating mechanism of the vehicle.

9. The method of claim 7, wherein the wireless signals include ultra-wide band signals.

10. The method of claim 7, wherein the protective equipment includes a helmet.

11. The method of claim 7, wherein the response includes limiting operation of the vehicle.

12. The method of claim 11, wherein limiting operation of the vehicle includes at least one selected from a group consisting of preventing starting of the vehicle, limiting a speed of the vehicle, limiting acceleration of the vehicle, and disabling one or more vehicle systems.

13. A system for responding to a vehicular accident, the system comprising:
a sensor assembly of a vehicle, the sensor assembly including a transceiver configured to generate and transmit a first wireless signal toward a seat of the vehicle and detect a reflection of the wireless signal,
a wireless communication interface of the vehicle, the wireless communication interface configured to wirelessly communicate with a remote device associated with a rider of the vehicle; and
a controller including an electronic processor, the electronic processor configured to:
determine whether the rider of the vehicle is wearing protective equipment based on the detected reflections of the wireless signal, and
in response to detection of an accident involving the vehicle:
transmit a second wireless signal from the wireless communication interface to the remote device,
determine a distance between the wireless communication interface and the remote device based on the second wireless signal,
determine an accident severity based on the determined distance between the wireless communication interface and the remote device and the determination of whether the rider of the vehicle is wearing protective equipment, and
initiate one or more actions to respond to the accident based on the determined accident severity.

14. The system of claim 13, wherein the first wireless signal includes an ultra-wideband signal.

15. The system of claim 13, wherein the wireless communication interface wirelessly communicates with the remote device via a short-range communication protocol.

16. The system of claim 13, wherein the electronic processor is configured to determine the distance using a Received Signal Strength method.

17. The system of claim 13, wherein the protective equipment includes a helmet.

18. The system of claim 13, wherein the one or more actions includes at least one selected from a group consisting of communicating a notification to the remote device, communicating with an accident assistance service, activating a light of the vehicle, and activating a sound-generating mechanism of the vehicle.

19. The system of claim 18, wherein the electronic processor is further configured to transmit at least one of the accident severity and information indicative of whether the rider is wearing protective equipment to an accident assistance service.

20. The system of claim 18, wherein the electronic processor is further configured to transmit, to an accident assistance service, location information of the rider relative to the vehicle based on the determined distance.
